(19) United States
(12) Patent Application Publication
(10) Pub. No.: US 2021/0104726 A1
(43) Pub. Date: Apr. 8, 2021

(54) ELECTROLYTIC SOLUTION FOR LITHIUM ION SECONDARY BATTERY AND A LITHIUM ION SECONDARY BATTERY

(71) Applicant: HONDA MOTOR CO., LTD., Tokyo (JP)

(72) Inventors: Kazuaki MATSUMOTO, Saitama (JP); Takeshi FUJINO, Saitama (JP)

(21) Appl. No.: 17/037,736

(22) Filed: Sep. 30, 2020

(30) Foreign Application Priority Data
Oct. 8, 2019 (JP) 2019-185332

(51) Int. Cl. H01M 4/13; H01M 10/0525

(52) U.S. Cl. CPC H01M 4/13; H01M 10/0525; H01M 2004/028; H01M 2300/0068; H01M 2300/0037

(57) ABSTRACT

The present invention provides an electrolytic solution for a lithium ion secondary battery containing imide-based lithium salt, and a lithium ion secondary battery that are able to block corrosion of aluminum and improve battery performance, even without increasing the concentration of the imide-based lithium salt.

A specific solvent mixture having a specific composition is used in the electrolytic solution containing the imide-based lithium salt. Specifically, the electrolytic solution uses a solvent mixture containing a first solvent and a second solvent mixed in a specific ratio, the first solvent interacting with an electrolyte salt and showing a shift of a peak attributed to vibration of the solvent to a different position in the Raman spectrum, the second solvent having no interaction with the electrolyte salt.

This application is based on and claims the benefit of priority from Japanese Patent Application No. 2019-185332, filed on 8 Oct. 2019, the content of which is incorporated herein by reference.

### BACKGROUND OF THE INVENTION

### Field of the Invention

The present invention relates to an electrolytic solution for a lithium ion secondary battery, and a lithium ion secondary battery using the electrolytic solution.

### Related Art

Lithium ion secondary batteries have been widely used as secondary batteries having a high energy density.

The lithium ion secondary battery using a liquid as an electrolyte includes a separator provided between a positive electrode and a negative electrode, and is filled with a liquid electrolyte (electrolytic solution).

Requirements for the lithium ion secondary battery vary depending on the application.

For example, when applied to automobiles, the battery is required to have high energy density and show output characteristics that are not greatly impaired even after repeated charging and discharging.

In such a conventional lithium ion secondary battery, a lithium salt used in the electrolytic solution reacts with water in the battery to produce hydrogen fluoride (HF).

Hydrogen fluoride thus produced causes elution of transition metals in the positive electrode active material, affecting the durability of the battery.

In order to protect the active material from deterioration, an imide-based compound salt, such as lithium bis(trifluoromethanesulfonyl)imide (LiTFSI), which produces no hydrogen fluoride (HF) even when it reacts with water has been proposed (see Patent Document 1).

The imide-based compound salt such as LiTFSI has a higher degree of dissociation and higher lithium ion conductivity than LiPF₆. However, the imide-based compound salt causes corrosion of the collector made of aluminum or the like, because a nonconductor film is not formed on the collector.

As a solution to this problem, a method of forming a coating on the aluminum collector by blending a specific additive in an electrolytic solution containing an imide-based compound as the salt has been proposed (see Patent Document 2).

Patent Document 2 describes a technique of blending at least one selected from the group consisting of LiPFₘ(CₖF₂ₖ₊1)₆₋ₘ (0≤m≤6, 1≤k≤2), LiBFₙ(CⱼF₂ⱼ₊1)₄₋ₙ (0≤n≤4, 1≤j≤2), and LiAsF₆ in an electrolytic solution containing lithium bis(fluorosulfonyl)imide.

According to another proposed technique, the aluminum collector is treated at high temperature in advance to form an oxide coating on the surface of the collector, thereby blocking a corrosion reaction between the aluminum collector and imide-based anions (see Patent Document 3).

Further, according to still another proposed technique, the concentration of lithium bis(trifluoromethanesulfonyl)imide (LiTFSI), which is an imide-based lithium salt, is raised to form a film that blocks the corrosion of aluminum during the charge of the battery (see Patent Document 4).

Patent Document 1: Japanese Unexamined Patent Application, Publication No. 2010-165653

Patent Document 2: Japanese Unexamined Patent Application, Publication No. 2004-165151

Patent Document 3: Japanese Unexamined Patent Application, Publication No. 2007-299724

Patent Document 4: PCT International Publication No. WO2010/030008

### SUMMARY OF THE INVENTION

However, the additive according to Patent Document 2 lowers lithium ion conductivity because the anions having a large molecular structure cause steric hindrance.

Thus, if a large amount of the additive is blended, resistance of the battery increases, and battery performance (especially the rate characteristics) deteriorates.

According to the technique of Patent Document 3 of treating the aluminum collector at high temperature to form a coating on the collector surface, the coating cannot be easily made uniform depending on how the heat transfers or the state of the surface.

Therefore, this technique is not sufficient to block the corrosion of aluminum.

According to Patent Document 4, the electrolytic solution contains a high concentration of LiTFSI, which makes the electrolytic solution more viscous, and lowers the lithium ion conductivity.

This results in an increase in resistance of the battery, and a decrease in battery performance (especially the rate characteristics).

In view of the foregoing, the present invention has been made to provide an electrolytic solution for a lithium ion secondary battery containing an imide-based lithium salt, and a lithium ion secondary battery that is able to block a corrosion reaction with aluminum and improve battery performance, even without increasing the concentration of the imide-based lithium salt.

The present inventors have found that the problems described above can be solved by using a specific solvent mixture in a specific composition in the electrolytic solution containing the imide-based lithium salt, and have made the present invention.

Specifically, the present invention is directed to an electrolytic solution including: an organic solvent mixture containing a plurality of organic solvents mixed together; and an electrolyte salt, wherein the electrolyte salt contains a lithium salt including N-(imide)-based anions, the lithium salt including N-(imide)-based anions in the electrolytic solution has a concentration of 0.1 mol/L to 1.2 mol/L, the organic solvent mixture includes a first solvent and a second solvent, the first solvent interacts with the electrolyte salt and shows a shift of the peak attributed to vibration of the solvent to a different position in the Raman spectrum, the second solvent does not interact with the electrolyte salt, the first solvent is contained in a ratio of 40 vol % or more to the whole organic solvent mixture, and the second solvent is contained in a ratio of 60 vol % or less to the whole organic solvent mixture.

When the peak attributed to the vibration of the solvent has an intensity Io, and the peak lowered by the interaction between the solvent and the electrolyte salt has an intensity Is, the first solvent may have a ratio Is/Io of 0.1 or more and 0.6 or less.

The second solvent may contain halogen atoms.

The second solvent may be trifluoroethyl phosphate.

The second solvent may have a dielectric constant of 10 or less.

Cations constituting the electrolyte salt may contain quaternary ammonium.

Another aspect of the present invention is directed to a lithium ion secondary battery including: a positive electrode; a negative electrode; and the electrolytic solution for the lithium ion secondary battery described above.

The electrolytic solution for the lithium ion secondary battery containing the lithium imide salt according to the present invention can form a coating derived from the lithium imide salt, and can block the corrosion of aluminum, even without increasing the concentration of the lithium imide salt.

This can sufficiently block corrosion of a collector made of aluminum and a can used as an exterior body.

Further, use of the lithium imide salt having a high degree of dissociation and high ion conductivity can reduce the battery resistance and can improve the rate characteristics of the battery, and in addition, can improve the cycle characteristics (capacity retention) of the battery.

### BRIEF DESCRIPTION OF THE DRAWINGS

FIG. 1 shows Raman spectra of electrolytic solutions prepared in Examples and Comparative Examples, TFP alone, and an organic solvent mixture containing EC, EMC, and DMC in a volume ratio of 30:40:30.

### DETAILED DESCRIPTION OF THE INVENTION

Embodiments of the present invention will be described below. The present invention is not limited to the following embodiments.

<Electrolytic Solution for Lithium Ion Secondary Battery>

An electrolytic solution for a lithium ion secondary battery of the present invention is an electrolytic solution containing an organic solvent mixture containing a plurality of organic solvents mixed together, and an electrolyte salt.

[Electrolyte Salt]

The electrolyte salt contained in the electrolytic solution for the lithium ion secondary battery of the present invention contains a lithium salt including N-(imide)-based anions.
The lithium salt including N-(imide)-based anions has a higher degree of dissociation and higher lithium ion conductivity than other lithium salts such as LiPF₆, LiBF₄, LiClO₄, and LiCF₃SO₃.
Further, the lithium salt produces no hydrogen fluoride (HF) due to its low reactivity with water, and has low reactivity with transition metals.
This can keep the capacity of the battery from decreasing, and can improve the cycle characteristics.

The lithium salt including N-(imide)-based anions is not particularly limited. Examples thereof include: lithium phosphonyl imide salt such as LiN(SO₂F)₂ (lithium bis(fluorophosphonyl)imide: LiFSI), LiN(CF₃SO₂)₂ (lithium bis(trifluoromethanesulfonyl)imide: LiTFSI), LiN(C₂F₅SO₂)₂ (lithium bis(pentafluoroethanesulfonyl)imide: LiBETI), LiN(C₄F₉SO₂)₂ (lithium bis(nonafluorobutanesulfonyl)imide), CF₃—SO₂—N—SO₂—N—SO₂CF₃Li, FSO₂—N—SO₂—C₄F₉Li, CF₃—SO₂—N—SO₂—CF₂—SO₂—N—SO₂—CF₃Li₂, and CF₃—SO₂—N—SO₂—CF₂—SO₂—C(—SO₂CF₃)₂Li₂; LiN(CF₂SO₂)₂ (CF₂) having a five-membered ring structure; and LiN(CF₂SO₂)₂(CF₂)₂ having a six-membered ring structure.

In the present invention, these compounds may be used alone, or in combinations of two or more.

The electrolytic solution for the lithium ion secondary battery of the present invention may optionally contain other lithium salts as long as the electrolytic solution contains the lithium salt including N-(imide)-based anions as an essential component of the electrolyte salt.

Examples of the electrolyte salt that can be optionally contained include lithium salts such as LiPF₆, LiAsF₆, LiAlCl₄, LiClO₄, LiBF₄, LiSbF₆, Li₂SO₄, Li₃PO₄, Li₂HPO₄, LiH₂PO₄, LiCF₃SO₃, and LiC₄F₉SO₃.

Cations constituting the electrolyte salt contained in the electrolytic solution for the lithium ion secondary battery of the present invention preferably contain quaternary ammonium.

The cations containing quaternary ammonium make the electrolytic solution difficult to be volatilized, and improve the thermal stability of the electrolytic solution.

Examples of quaternary ammonium contained in the cations of the electrolyte salt include imidazolium, pyrrolidinium, and piperidinium. These quaternary ammoniums desirably improve the ion conductivity when mixed with the electrolytic solution.

Thus, the electrolyte salt contained in the electrolytic solution for the lithium ion secondary battery of the present invention contains the lithium salt including N-(imide)-based anions, and preferably contains quaternary ammonium.

(Concentration of Electrolyte Salt)

The lithium salt including N-(imide)-based anions in the electrolytic solution for the lithium ion secondary battery of the present invention has a concentration of 0.1 mol/L to 1.2 mol/L, preferably in the range of 0.2 mol/L to 1.0 mol/L.

Further, in the electrolytic solution for the lithium ion secondary battery of the present invention, the total concentration of the electrolyte salt, which is the sum of the concentrations of the lithium salt including N-(imide)-based anions and other optional electrolyte salts, is preferably 0.5 mol/L to 2.5 mol/L, and more preferably the concentration of the N-(imide)-based anions is in the range of 0.8 mol/L to 1.2 mol/L.

The electrolytic solution of the present invention can form a nonconductor film even without adding a high concentration of the imide-based lithium salt.

This can block the corrosion of aluminum, and can improve the battery performance.

[Organic Solvent Mixture]

The organic solvent mixture constituting the electrolytic solution for the lithium ion secondary battery of the present invention is a mixture of a first solvent and a second solvent.

Among the solvents constituting the organic solvent mixture, the first solvent interacts with the electrolyte salt and shows a shift of the peak attributed to vibration of the solvent to a different position in the Raman spectrum, and the second solvent does not interact with the electrolyte salt.

To the whole organic solvent mixture, the first solvent is contained in a ratio of 40 vol % or more, and the second solvent is contained in a ratio of 60 vol % or less.

The electrolytic solution for the lithium ion secondary battery of the present invention containing the organic solvent mixture configured as described above has a “low solvation structure” in which the number of solvent molecules that solvate with the lithium ions is reduced.

In the electrolytic solution having the “low solvation structure”, the lithium ions and the imide-based anions in the electrolytic solution are close to each other, and thus, a coating derived from the imide-based lithium salt can be formed.

Specifically, at the initial charge, the reaction between the lithium ions and the imide-based anions takes preference over the solvent reaction on the aluminum collector, thereby forming the coating. This coating blocks the corrosion reaction of aluminum.

On the other hand, if the concentration of the imide-based lithium salt is low (e.g., less than 1.0 mol/L) in a conventional electrolytic solution having no “low solvation structure”, most of the imide-based lithium salt solvates in the electrolytic solution.

Thus, many solvent molecules are present between the lithium ion and the imide-based anion, increasing the distance these ions are apart from each other.
This makes it difficult to form the coating derived from the imide-based lithium salt on the current collector foil.

Therefore, in order to form the coating derived from the imide-based lithium salt by a conventional technique, the concentration of the imide-based lithium salt in the conventional electrolytic solution is increased so that the imide-based lithium salt that does not solvate is present in the solution.

However, increasing the concentration of the imide-based lithium salt makes the electrolytic solution more viscous, and lowers the lithium ion conductivity of the electrolytic solution.
This results in an increase in resistance of the battery, and a decrease in battery performance (especially the rate characteristics).

According to the present invention, the organic solvent mixture constituting the electrolytic solution is configured as a solvent mixture that does not easily solvate with the lithium ions. Thus, the number of solvent molecules that solvate with the lithium ions can be reduced even without increasing the concentration of the imide-based lithium salt. This causes the lithium ions and the imide-based anions to be close to each other.

As a result, the coating derived from the imide-based lithium salt is easily formed on the aluminum surface, and the coating thus formed can block the corrosion reaction of aluminum.
Since it is no longer necessary to increase the concentration of the imide-based lithium salt, the viscosity of the electrolytic solution can be reduced by selecting a suitable solvent species. This can reduce the increase in the battery resistance, and can improve the battery performance (especially the rate characteristics).
In addition, the salt concentration can be reduced, and thus, the cost of the electrolytic solution can also be reduced.

(First Solvent)

The first solvent constituting the organic solvent mixture in the electrolytic solution of the present invention easily interacts with the electrolyte salt in the electrolytic solution, and easily forms a solvation structure with the electrolyte salt.
Specifically, the first solvent solvates with the electrolyte salt dissolved therein, and shows a shift of the peak to a different position in the Raman spectrum.
The shifting lowers the intensity of the solvent peak at the original position.
The first solvent mainly has the function of adjusting the solubility of the lithium salt, and the function of forming an initial nonconductor film (initial SEI).

In the present invention, the “peak” in the Raman spectrum means a point having a height (a vertex of intensity) greater than the intensity of the background.

In the Raman spectrum, the “shift” of the “peak” means that the period of vibration of solvent molecules has changed, i.e., the magnitude of electrical interaction between the electrolyte ions and the solvent has changed.
In other words, when there is no “peak shift”, there is little electrical interaction between the target solvent molecules and the electrolyte ions.
Further, when the peak attributed to the vibration of the solvent has an intensity Io, and the peak lowered by the interaction between the solvent and the electrolyte salt has an intensity Is, the “different position” is a point where the position of Is (cm⁻¹) is greater than the peak position of Io (cm⁻¹) by +10% or more.

When the peak attributed to the vibration of the solvent has an intensity Io, and the peak lowered by the interaction between the solvent and the electrolyte salt has an intensity Is, the first solvent in the electrolytic solution of the present invention preferably has a ratio Is/Io of 0.1 or more and 0.6 or less.

The ratio Is/Io of the first solvent is more preferably 0.2 or more.

If the ratio Is/Io of the first solvent is less than 0.1, the number of solvent molecules that do not solvate with the lithium ions in the electrolytic solution is too small. This makes the dissolution of the electrolyte salt unstable, and the function of the electrolytic solution cannot be sufficiently exerted.

If the ratio exceeds 0.6, the low solvation structure becomes insufficient, and the coating is not easily formed on the current collector foil at the initial charge, making it difficult to exert the effect of blocking the corrosion.

Examples of the first solvent include organic solvents having a cyclic structure such as ethylene carbonate (EC) and propylene carbonate (PC), and organic solvents having a chain structure such as dimethyl carbonate (DMC), ethyl methyl carbonate (EMC), and diethyl carbonate (DEC).

In the electrolytic solution of the present invention, the first solvent is contained in a ratio of 40 vol % or more to the whole organic solvent mixture.

When the ratio of the first solvent is 40 vol % or more to the whole organic solvent mixture, a sufficient amount of electrolyte salt is dissolved, and a suitable distance can be kept between the imide-based anions and the lithium ions. This can block the corrosion of the foil by the coating formed on the aluminum collector foil.
If the ratio is 60 vol % or more, the viscosity of the electrolytic solution can be sufficiently lowered. This can improve the rate characteristics, and enhance the charge/discharge performance.

The ratio of the first solvent to the whole organic solvent mixture is preferably 60 vol % or more.

Further, the ratio is more preferably 90 vol % or less to the whole organic solvent mixture.

(Second Solvent)

In the electrolytic solution of the present invention, the second solvent does not interact with the electrolyte salt.
Specifically, the second solvent does not solvate with the electrolyte salt dissolved therein, and shows a peak at a different position in the Raman spectrum.
The second solvent mainly has the function of maintaining the state of the solvate formed by the first solvent, and lowering the concentration of the electrolyte salt in the electrolytic solution. Specifically, the presence of the second solvent can lower the viscosity of the electrolytic solution and the concentration of the electrolyte salt while having a low coordination structure.

In the present invention, when the peak attributed to the vibration of the solvent has an intensity Io, and the peak of the solvent itself lowered by the interaction between the solvent and the electrolyte salt has an intensity Is in the Raman spectrum, having “no interaction” with the electrolyte salt means that the ratio Is/Io is less than 0.1.

The second solvent is contained in a ratio of 60 vol % or less to the whole organic solvent mixture.

When the ratio of the second solvent is 60 vol % or less to the whole organic solvent mixture, the electrolyte salt is dissociated to have sufficient ion conductivity, and simultaneously, the lithium ions and the imide-based anions can be kept close to each other.

The ratio of the second solvent to the whole organic solvent mixture is preferably 40 vol % or less.

The ratio is more preferably 10 vol % or more to the whole organic solvent mixture.

The second solvent preferably has a dielectric constant of 10 or less.

The dielectric constant of the second solvent is more preferably 5 or less.
When the dielectric constant of the second solvent is 10 or less, the interaction with the lithium ions can be sufficiently reduced, which can consequently keep the state of the solvate formed between the lithium ions and the first solvent.

The first solvent has a dielectric constant of 20 or more. Thus, the solvent having a dielectric constant of 10 or less does not easily interact with the lithium ions in the electrolytic solution, and does not easily solvate with the lithium ions.

Thus, if the ratio of the solvent having a dielectric constant of 10 or less is increased in the organic solvent mixture constituting the electrolytic solution, the number of solvent molecules that solvate with the lithium ions can be reduced.
When a Raman shift of the electrolytic solution is observed to quantify the state of the solvate in this manner, the properties of the mixed electrolytic solution can be clearly grasped.

The second solvent is preferably a solvent containing halogen atoms.

The solvent containing the halogen atoms does not easily interact with the electrolyte salt in the electrolytic solution, and thus, does not easily solvate with the electrolyte salt.

The solvent preferably contains fluorine atoms as the halogen atoms.

The solvent containing fluorine does not interact with the lithium ions, and thus, is considered to contribute to stabilization of the state of the solvate, and promote the formation of the coating on the aluminum collector foil.

Specifically, if a suitable amount of the fluorine-based solvent that does not easily solvate with the electrolyte salt is mixed, the number of solvent molecules that solvate with the electrolyte salt can be adjusted more precisely, making fine adjustment to the distance between the cations and the anions.

Adjusting the number of solvent molecules that coordinate with the cations can produce a solvation structure which is stable even in a low coordination state. This can reduce the decrease in ion conductivity, can form the coating on the aluminum collector foil, and can block the decomposition reaction of the solvent in good balance.

Specifically, examples of the second solvent used in the organic solvent mixture of the electrolytic solution of the present invention include fluoroethylene carbonate (FEC) and difluoroethylene carbonate (DFEC) obtained by partially fluorinating a carbonate solvent, and a fluoride of phosphate, carboxylate, sulfate, hydrocarbon, or ether.

More specifically, examples of the second solvent include trifluoroethyl phosphate (TFP), trifluoroethyl carbonate, 1,1,2,2,-tetrafluoroethyl-2,2,2-trifluoroethyl ether, ethyl nonafluorobutyl ether, methyl tridecafluorohexyl ether, hydrofluoroether, bis(2,2,2-trifluoroethyl)ether, 2,2,3,3,3-pentafluoropropyl difluoromethyl ether, 2,2,3,3,3-pentafluoropropyl-1,1,2,2-tetrafluoroethyl ether, 1,1,2,2-tetrafluoroethylmethyl ether, 1,1,2,2-tetrafluoroethylethyl ether, 1,1,2,2-tetrafluoroethyl-2,2,2-trifluoroethyl ether, 1,1,2,2-tetrafluoroethyl-2,2,3,3-tetrafluoropropyl ether, hexafluoroisopropyl methyl ether, 1,1,3,3,3-pentafluoro-2-trifluoromethylpropylmethyl ether, 1,1,2,3,3,3-hexafluoropropylmethyl ether, 2,2,3,4,4,4-hexafluorobutyl difluoromethyl ether, methyl trifluoroacetate, ethyl trifluoroacetate, methyl perfluoropropionate, ethyl perfluoropropionate, methyl perfluorobutylate, ethyl perfluorobutylate, methyl difluoroacetate, ethyl difluoroacetate, ethyl 5H-octafluoropentanate, ethyl 7H-dodecafluoropentanate, methyl 2-trifluoromethyl-3,3,3-trifluoropropionate, methyl 3,3,3-trifluoropropionate, 2,2,2-trifluoroethyl acetate, 2,2,2-trifluoroethylmethyl carbonate, and difluoroethyl carbonate.

Among them, trifluoroethyl phosphate (TFP) is most preferable.

[Additive]

Any known additive may be blended in the electrolytic solution for the lithium ion secondary battery of the present invention.
Examples of the additive include vinylene carbonate (VC), vinyl ethylene carbonate (VEC), propane sultone (PS), and fluoroethylene carbonate (FEC).

<Lithium Ion Secondary Battery>

The lithium ion secondary battery of the present invention includes a positive electrode, a negative electrode, and the electrolytic solution for the lithium ion secondary battery of the present invention described above.

[Positive Electrode and Negative Electrode]

The positive and negative electrodes of the lithium ion secondary battery of the present invention are not particularly limited.
Any known positive and negative electrodes in the present technical field can be used.

The lithium ion secondary battery of the present invention includes the positive electrode, the negative electrode, and the electrolytic solution for the lithium ion secondary battery of the present invention described above as essential components, and may include other components such as a separator.

The lithium ion secondary battery of the present invention may include any kinds of batteries as long as the electrolytic solution for the lithium ion secondary battery of the present invention can be applied thereto.

That is, the lithium ion secondary battery may include any batteries except for all solid-state batteries.
Further, the battery shape is not particularly limited, and the lithium ion secondary battery may include batteries of any shape, e.g., can-type cells and laminated cells.

<Method for Manufacturing Lithium Ion Secondary Battery>

A method for manufacturing the lithium ion secondary battery of the present invention is not particularly limited, and a general method in the present technical field can be used.

### EXAMPLES

The present invention will be described in further detail by way of examples, but the invention is not limited thereto.

### Example 1

### [Production of Positive Electrode]

LiNi_{0.6}Co_{0.2}Mn_{0.2}O₂ as a positive electrode active material, acetylene black as a conductive agent, and polyvinylidene fluoride (PVDF) as a binder were mixed in a mass ratio of 94:2:4 in N-methyl-2-pyrrolidone (NMP) as a dispersion solvent to prepare positive electrode slurry.

The obtained positive electrode slurry was applied by a doctor blade method to 20 μm thick aluminum foil prepared as a current collector to form a positive electrode active material layer.

The obtained product was punched into a round shape having a diameter of 12 mm to form a positive electrode.

[Production of Negative Electrode]

Natural graphite as a negative electrode active material, styrene butadiene rubber (SBR) as a binder, and carboxymethyl cellulose (CMC) were mixed in a mass ratio of 97:1.5:1.5 in N-methyl-2-pyrrolidone (NMP) as a dispersion solvent to prepare negative electrode slurry.

The obtained negative electrode slurry was applied by a doctor blade method to 10 μm thick copper foil prepared as a current collector to form a negative electrode active material layer.

The obtained product was punched into a round shape having a diameter of 13 mm to form a negative electrode.

[Production of Lithium Ion Secondary Battery]

A 25 μm thick microporous film of polyethylene (PE) was prepared as a separator, and punched into a round shape having a diameter of 19 mm. This was arranged between the positive and negative electrodes formed as described above to produce a coin cell.

In an organic solvent mixture prepared by mixing ethylene carbonate (EC), dimethyl carbonate (DMC), ethyl methyl carbonate (EMC), and trifluoroethyl phosphate (TFP) in a volume ratio of 12:16:12:60, 1.0 mol/L of lithium bis(trifluoromethanesulfonyl)imide (LiTFSI) as an electrolyte salt was dissolved to produce an electrolytic solution.

### Example 2

A coin cell was produced in the same manner as in Example 1 except that the electrolytic solution was produced by dissolving 0.5 mol/L of LiPF₆ and 0.5 mol/L of LiTFSI as electrolyte salts in an organic solvent mixture prepared by mixing EC, DMC, EMC, and TFP in a volume ratio of 18:24:18:40.

### Comparative Example 1

A coin cell was produced in the same manner as in Example 1 except that the electrolytic solution was produced by dissolving 1 mol/L of LiTFSI as an electrolyte salt in an organic solvent mixture prepared by mixing EC, DMC, and EMC in a volume ratio of 30:40:30.

### Comparative Example 2

A coin cell was produced in the same manner as in Example 1 except that the electrolytic solution was produced by dissolving 3 mol/L of LiTFSI as an electrolyte salt in an organic solvent mixture prepared by mixing EC, DMC, and EMC in a volume ratio of 30:40:30.

### Comparative Example 3

A coin cell was produced in the same manner as in Example 1 except that the electrolytic solution was produced by dissolving 0.5 mol/L of LiPF₆ and 0.5 mol/L of LiTFSI as electrolyte salts in an organic solvent mixture prepared by mixing EC, DMC, and EMC in a volume ratio of 30:40:30.

<Evaluation>

The lithium ion secondary batteries obtained in the Examples and Comparative Examples were evaluated as follows.

[Initial Charge/Discharge Characteristics]

The produced lithium ion secondary batteries were charged at 0.1 C to 4.2 V, charged at a constant voltage of 4.2 V for an hour, and then discharged at 0.1 C to 2.5 V.
Charging capacity, discharging capacity, and charge/discharge efficiency at that time were respectively taken as initial charging capacity, initial discharging capacity, and initial charge/discharge efficiency.
Table 1 shows the results.

[Charge/Discharge Characteristics in Second Cycle]

After the measurement of the initial charge/discharge characteristics, the batteries were charged at 1 C to 4.2 V, charged at a constant voltage of 4.2 V for an hour, and then discharged at 1 C to 2.5 V.
Charging capacity, discharging capacity, and charge/discharge efficiency at that time were respectively taken as charging capacity, discharging capacity, and charge/discharge efficiency in the second cycle.

Table 1 shows the results.

TABLE 1

| | | | | Comparative | Comparative | Comparative |
|---|---|---|---|---|---|---|
| | | Example 1 | Example 2 | Example 1 | Example 2 | Example 3 |
| Initial | Charging | 4.8 | 4.9 | 5.2 | 4.7 | 5.0 |
| cycle | capacity | | | | | |
| | (mAh) | | | | | |
| | Discharging | 4.1 | 4.3 | 3.2 | 4.0 | 3.7 |
| | capacity | | | | | |
| | (mAh) | | | | | |
| | Charge/discharge | 85 | 88 | 62 | 85 | 74 |
| | efficiency | | | | | |
| | (%) | | | | | |
| Second | Charging | 3.9 | 4.1 | 2.8 | 3.0 | 3.5 |
| cycle | capacity | | | | | |
| | (mAh) | | | | | |
| | Discharging | 3.7 | 3.9 | 0.2 | 2.0 | 2.8 |
| | capacity | | | | | |
| | (mAh) | | | | | |
| | Charge/discharge | 94 | 95 | 7 | 67 | 80 |
| | efficiency | | | | | |
| | (%) | | | | | |

The electrolytic solution of Comparative Example 1 had an increased irreversible capacity at the initial charge, indicating that a corrosion reaction between LiTFSI and the aluminum collector occurred.

The electrolytic solution of Comparative Example 2 containing a high concentration of LiTFSI improved the initial charge/discharge efficiency, indicating that the corrosion of aluminum was blocked. However, the electrolytic solution of Comparative Example 2 decreased the charging and discharging capacities in the second cycle.
This indicates that the high LiTFSI concentration in the electrolytic solution increased the battery resistance, and decreased the capacity.

The electrolytic solution of Comparative Example 3 dissolving LiPF₆ and LiTFSI blocked the corrosion reaction of the aluminum collector, and made the charge/discharge efficiency higher than that of Comparative Example 1.

However, the capacity significantly decreased in the second cycle, indicating that the corrosion of aluminum was not blocked completely.

On the other hand, the electrolytic solution of Example 1 containing TFP, which is an organic solvent that does not interact with the electrolyte salt, showed high charge/discharge efficiency even when mixed with LiTFSI.

This indicates that the reduced number of solvent molecules that solvate with the lithium ions allowed a coating derived from a decomposition product of LiTFSI to be formed on the aluminum surface, thereby blocking the corrosion reaction of aluminum.

Further, the electrolytic solution of Example 2 mixed with TFP and dissolving LiTFSI and LiPF₆ blocked the corrosion of aluminum, and showed high charge/discharge capacity even in the second charge/discharge cycle because of low viscosity of the electrolytic solution derived from the low concentration of the electrolyte salt.

Specifically, the results indicate that the corrosion of aluminum was blocked without increasing the concentration of LiTFSI in the electrolytic solution.
The low concentration of the electrolyte salt does not lead to an increase in initial resistance.

[Is/Io in Raman Spectrum Analysis]

The intensity Io of the peak attributed to the vibration of the solvent and the intensity Is of the peak shifted by the interaction between the solvent and the electrolyte salt were specified in the following manner.

First, Raman spectra of the electrolytic solutions of Examples 1 and 2 and Comparative Examples 1 to 3, TFP alone, and an organic solvent mixture of EC, EMC, and DMC mixed in a volume ratio of 30:40:30 were measured.

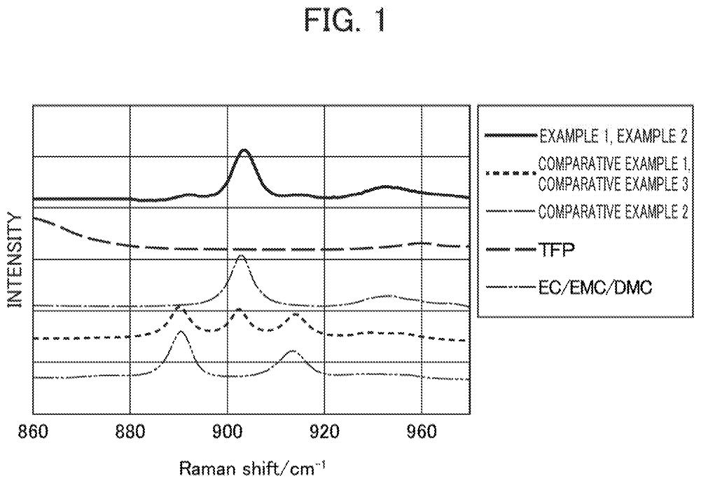

FIG. 1 shows the obtained spectra.
Table 2 shows the values Is/Io calculated from the obtained Raman spectra.

TABLE 2

Is/Io

| | EC | DMC | EMC | TFP |
|---|---|---|---|---|
| Example 1 | 0.3 | 2.2 | 1.2 | 0 |
| Example 2 | 0.3 | 2.2 | 1.2 | 0 |
| Comparative Example 1 | 0.8 | 0.2 | 0.6 | — |
| Comparative Example 2 | 0.2 | 1.6 | 0.8 | — |
| Comparative Example 3 | 0.8 | 0.2 | 0.6 | — |

The organic solvent mixture of EC, DMC, and EMC mixed in a volume ratio of 30:40:30 showed peaks at 890 cm⁻¹ derived from EC, 915 cm⁻¹ from DMC, and 938 cm⁻¹ from EMC.

The electrolytic solution of Comparative Example 1 to which 1 mol/L of LiTFSI was added showed new peaks at around 903 cm⁻¹, 930 cm⁻¹, and 945 cm⁻¹.

This is because the lithium salt dissolved in the electrolytic solution caused EC, DMC, and EMC corresponding to the first solvent in the organic solvent mixture to solvate with the lithium ions, and the peaks were shifted.

The electrolytic solution of Comparative Example 2 dissolving 3 mol/L of LiTFSI increased the lithium ion concentration, and thus, the peak derived from the solvation was mainly observed.

Although the solvent of TFP alone showed a peak at around 860 cm⁻¹, no new peaks derived from the solvate of TFP were observed from the electrolytic solution of Example 1 in which 60 vol % of TFP was mixed and the lithium salt was dissolved, and the electrolytic solution of Example 2 in which 40 vol/% of TFP was mixed.

Specifically, TFP does not easily solvate with the lithium ions serving as the electrolyte salt, and thus, showed no new peak.

What is claimed is:

1. An electrolytic solution for a lithium ion secondary battery, the electrolytic solution comprising: an organic solvent mixture containing a plurality of organic solvents mixed together; and an electrolyte salt, wherein
the electrolyte salt includes a lithium salt comprising N-(imide)-based anions,
the lithium salt comprising N-(imide)-based anions in the electrolytic solution has a concentration of 0.1 mol/L to 1.2 mol/L,
the organic solvent mixture includes a first solvent and a second solvent,
the first solvent interacts with the electrolyte salt and shows a shift of a peak attributed to vibration of the solvent to a different position in a Raman spectrum,
the second solvent does not interact with the electrolyte salt,
the first solvent is contained in a ratio of 40 vol % or more to the whole organic solvent mixture, and
the second solvent is contained in a ratio of 60 vol % or less to the whole organic solvent mixture.

2. The electrolytic solution for the lithium ion secondary battery of claim 1, wherein when the peak attributed to the vibration of the solvent has an intensity Io, and a peak lowered by the interaction between the solvent and the electrolyte salt has an intensity Is, the first solvent has a ratio Is/Io of 0.1 or more and 0.6 or less.

3. The electrolytic solution for the lithium ion secondary battery of claim 1, wherein the second solvent contains halogen atoms.

4. The electrolytic solution for the lithium ion secondary battery of claim 1, wherein the second solvent is trifluoroethyl phosphate.

5. The electrolytic solution for the lithium ion secondary battery of claim 1, wherein the second solvent has a dielectric constant of 10 or less.

6. The electrolytic solution for the lithium ion secondary battery of claim 1, wherein cations constituting the electrolyte salt contain quaternary ammonium.

7. A lithium ion secondary battery comprising: a positive electrode; a negative electrode; and the electrolytic solution for the lithium ion secondary battery of claim 1.

8. The electrolytic solution for the lithium ion secondary battery of claim 2, wherein the second solvent contains halogen atoms.

9. The electrolytic solution for the lithium ion secondary battery of claim 2, wherein the second solvent is trifluoroethyl phosphate.

10. The electrolytic solution for the lithium ion secondary battery of claim 3, wherein the second solvent is trifluoroethyl phosphate.

11. The electrolytic solution for the lithium ion secondary battery of claim 2, wherein the second solvent has a dielectric constant of 10 or less.

12. The electrolytic solution for the lithium ion secondary battery of claim 3, wherein the second solvent has a dielectric constant of 10 or less.

13. The electrolytic solution for the lithium ion secondary battery of claim 4, wherein the second solvent has a dielectric constant of 10 or less.

14. The electrolytic solution for the lithium ion secondary battery of claim 2, wherein cations constituting the electrolyte salt contain quaternary ammonium.

15. The electrolytic solution for the lithium ion secondary battery of claim 3, wherein cations constituting the electrolyte salt contain quaternary ammonium.

16. The electrolytic solution for the lithium ion secondary battery of claim 4, wherein cations constituting the electrolyte salt contain quaternary ammonium.

17. The electrolytic solution for the lithium ion secondary battery of claim 5, wherein cations constituting the electrolyte salt contain quaternary ammonium.

18. A lithium ion secondary battery comprising: a positive electrode; a negative electrode; and the electrolytic solution for the lithium ion secondary battery of claim 2.

19. A lithium ion secondary battery comprising: a positive electrode; a negative electrode; and the electrolytic solution for the lithium ion secondary battery of claim 3.

20. A lithium ion secondary battery comprising: a positive electrode; a negative electrode; and the electrolytic solution for the lithium ion secondary battery of claim 4.
